(19) United States
(12) Patent Application Publication
(10) Pub. No.: US 2026/0289342 A1
(43) Pub. Date: Sep. 24, 2026

(54) SYSTEM AND METHOD FOR TOLERANCE-PARAMETERIZED RE-VERIFICATION IN DISTRIBUTED COMPUTING ENVIRONMENTS

(71) Applicant: Michael Duane Cooper, Eagle, ID (US)

(72) Inventor: Michael Duane Cooper, Eagle, ID (US)

(21) Appl. No.: 19/565,203

(22) Filed: Mar. 12, 2026

(51) Int. Cl. G06N 5/025; G06F 9/48

(52) U.S. Cl. CPC G06N 5/025; G06F 9/4881

(57) ABSTRACT

A system and method for re-executing a deterministic verification engine with programmatically expanded tolerance parameters to produce a revised verification outcome. When task attestation evidence marginally fails verification against acceptance criteria with defined tolerance bands, the system computes expanded tolerance band definitions by applying per-dimension expansion rules to the original tolerance parameters and re-executes the same verification engine against the same evidence. The expansion is deterministic, per-dimension, and rules-based—not discretionary human judgment. Both the original and revised outcomes are atomically recorded in a tamper-evident audit chain within a single database transaction. Applications include automated dispute resolution, graduated acceptance policies, and settlement signal supersession. The mechanism eliminates human review for marginal verification failures while maintaining a complete, cryptographically verifiable audit trail of every re-verification decision.

### CROSS-REFERENCE TO RELATED APPLICATIONS

This application claims the benefit of U.S. Provisional Application No. 63/999,676, filed Mar. 8, 2026, under 35 U.S.C. § 119 (e), which is hereby incorporated by reference in its entirety.

This application is related to co-pending U.S. Non-Provisional application Ser. No. 19/564,768 (filed Mar. 12, 2026), titled “System and Method for Cascading Verification with Sibling-Complete Aggregation in Hierarchical Delegation Structures,” which describes the delegation chain verification architecture within which the re-verification mechanism of the present invention may operate.

This application is related to co-pending U.S. Non-Provisional application Ser. No. 19/565,072 (filed Mar. 12, 2026), titled “System and Method for Verification-Derived Settlement Signaling in Distributed Computing Systems,” which describes the settlement signal generation pipeline that consumes the re-verification outcomes produced by the present invention. In particular, a RELEASE signal as described in that application is emitted when the re-verification of the present invention produces a passing outcome that supersedes a prior failing outcome.

This application is related to co-pending U.S. Provisional Application No. 63/999,674 (filed Mar. 8, 2026), titled “Method and System for Two-Phase Verification of Task Attestation in Multi-Agent Computing Environments,” which describes the underlying verification engine and tolerance band architecture upon which the present invention builds.

### FIELD OF THE INVENTION

The present invention relates generally to automated verification systems in distributed computing environments, and more particularly to a method and system for re-executing a deterministic verification engine with programmatically modified tolerance parameters to produce a revised verification outcome, and for atomically recording both the original and revised outcomes in a tamper-evident audit chain within a single database transaction.

### BACKGROUND OF THE INVENTION

### Technical Problem

In distributed computing environments, computational entities-including autonomous software agents, microservices, robotic process automation (RPA) workflows, IoT device controllers, orchestration engines, and human-supervised automated systems-execute tasks on behalf of principals. When a computational entity completes a task, a verification system compares the entity's reported evidence against pre-registered acceptance criteria with defined tolerance bands. For example, a task specification record may specify a target quantity of 500 units with a 5% tolerance (permitting 475-525 units), a price ceiling of $2,250 with a $50 margin, and a deadline with an 86,400-second grace period.

The verification engine evaluates each criterion independently, applying the specified tolerance band, and produces a binary per-criterion result (pass or fail). The overall verification outcome is the logical conjunction of all per-criterion results: all criteria must pass for the task specification record to receive a passing verification outcome.

A fundamental technical problem arises when the verification engine produces a failing outcome where one or more criteria fall marginally outside their tolerance bands. In current systems, the only recourse is one of: (a) escalation to human review—an expensive, slow, and non-deterministic process; (b) permanent acceptance of the failing outcome—which may be unjust when the deviation is marginal; or (c) manual parameter adjustment and re-submission-which requires human intervention, introduces inconsistency, and creates audit trail gaps.

Human reviewers must re-examine all evidence, understand the tolerance band definitions, mentally recompute whether the deviation is within an acceptable range, and make a subjective judgment. This process introduces inconsistency (different reviewers reach different conclusions on identical evidence), latency (hours to days), and cost (per-review fees). In enterprise environments processing thousands of task verifications daily, the volume of marginal failures requiring human review creates a bottleneck that prevents timely resolution.

The present invention addresses this problem by re-executing the same deterministic verification engine that produced the original failing outcome, using programmatically expanded tolerance parameters while keeping the task attestation evidence unchanged. The expansion is computed by applying per-dimension rules (multiplicative factors, additive increments, default value insertions) to the original tolerance band definitions, producing a wider but deterministic acceptance region. Because the verification engine is a pure function—identical inputs always produce identical outputs—the re-verification is fully reproducible and auditable. Both the original and revised outcomes, together with the expansion parameters applied, are atomically recorded in a tamper-evident audit chain within a single database transaction, ensuring that no verification decision can be retroactively altered without detection. The entire mechanism operates independently of any shared ledger or consensus protocol, requiring only a conventional relational database.

### Limitations of Existing Approaches

Several categories of prior art address aspects of this problem, but none provides the specific technical mechanism of the present invention:

Monetary Range Matching Systems. SquareTrade (US20040059596A1) and Cybersettle (U.S. Pat. No. 6,330,551B1, U.S. Pat. No. 8,150,774) implement automated dispute resolution between two parties by comparing monetary settlement offers. SquareTrade determines whether offers from opposing parties fall “within a predetermined range” of each other (e.g., within 20%) and proposes a midpoint. Cybersettle uses double-blind bidding where parties submit confidential monetary amounts. Critically, these systems expand negotiation windows between human parties, not verification criteria against pre-registered acceptance specifications. They do not re-execute a verification engine, do not operate on multi-dimensional tolerance bands, and do not compare task completion evidence against contractual acceptance criteria. The “range” in these systems refers to the gap between two parties' offers, not to the tolerance band on acceptance criteria for task verification.

Juror-Based Arbitration Platforms. Kleros, Aragon Court, and Jur are decentralized dispute resolution platforms that use Schelling Point game theory: randomly selected jurors review evidence and vote, with jurors who vote with the majority receiving rewards. These systems involve no automated re-adjudication whatsoever. Every dispute requires human juror participation, introducing latency, cost, and non-determinism. There is no mechanism to determine whether marginal criteria failures could be resolved by systematic tolerance expansion without human involvement.

Evidence Compilation Systems. Stripe Smart Disputes and similar payment dispute systems automatically compile evidence packages (shipping records, customer communications, transaction logs) for human review by card issuers. The system assists human decision-making but performs no automated re-adjudication. The dispute outcome is determined by the human reviewer, not by re-executing verification logic with modified parameters.

Rule-Based Validation Engines. US20110276531A1 and similar prior art describe rule-based engines for validating transaction data against fraud detection criteria. These systems do not verify task completion against agreement-time acceptance criteria, do not implement per-criterion tolerance bands defined at agreement creation time, and do not provide a re-verification mechanism with modified tolerance parameters.

Graduated SLA Systems. Service level agreement monitoring systems (e.g., U.S. Pat. No. 8,578,017) compare service metrics against committed thresholds and may define multiple SLA tiers (gold, silver, bronze). However, these systems define the tiers at agreement time as fixed, independent thresholds—they do not derive a second set of parameters by programmatically expanding the first set. There is no re-execution of a verification engine; the metric either meets or fails to meet a predefined threshold.

Retry and Resubmission Mechanisms. Conventional retry mechanisms in distributed systems (exponential backoff, circuit breakers) re-execute a failed operation with the same parameters. They do not modify the acceptance criteria or tolerance parameters between executions. The present invention is fundamentally different: it re-executes the verification engine with deliberately modified tolerance parameters while keeping the evidence unchanged.

Quality Control Tolerance Systems. Statistical process control (SPC) systems in manufacturing define tolerance zones (zones A, B, C) around a process mean. While conceptually related, these systems define all zones at process setup time and classify samples into pre-existing zones. They do not re-execute a verification engine with expanded parameters in response to a marginal failure; the zones are static classification boundaries, not dynamically expanded re-verification parameters.

Smart Contract and Escrow Systems. Ethereum smart contracts, Chainlink oracle-verified delivery triggers, and blockchain-based escrow protocols tie settlement execution to on-chain ledger state: when a condition is met on the ledger, the contract self-executes a payment or asset transfer. The present invention differs in three fundamental respects. First, smart contracts conflate verification and settlement into a single atomic ledger operation, whereas the present invention separates verification from settlement—the verification engine produces an informational signal (SETTLE, HOLD, or RELEASE), not a settlement transaction. The signal is advisory or binding depending on the consuming system's configuration, and the consuming system retains authority over actual settlement execution. Second, smart contracts have no concept of tolerance-band expansion or re-verification; the contract condition either evaluates to true or false, with no mechanism to programmatically widen acceptance criteria and re-evaluate. Third, the present invention operates independently of any shared ledger or consensus protocol—the verification engine, tolerance expansion, and audit chain all execute within a conventional relational database transaction, requiring no distributed consensus, gas fees, or blockchain finality delays.

CI/CD Quality Gate Systems. Continuous integration and continuous delivery pipelines (Jenkins, GitHub Actions, ArgoCD, CircleCI) implement quality gates where automated tests produce a boolean outcome (pass/fail) that gates a downstream action (deployment, merge, release). An examiner might analogize this to “verification→signal.” However, CI/CD quality gates differ from the present invention in every structural dimension: (a) CI/CD gates operate within a single organization's deployment pipeline, not across organizational or governance boundaries; (b) CI/CD gates produce boolean pass/fail outcomes with no per-criterion tolerance bands—a test either passes or fails, with no concept of “marginal failure within an expandable tolerance range”; (c) CI/CD gates have no tolerance expansion mechanism—a failed test is re-run with identical parameters (retry), not with systematically widened acceptance criteria; (d) CI/CD gates emit no cryptographically signed settlement signals to external payment or fulfillment systems; and (e) CI/CD gates do not maintain a tamper-evident, hash-chained audit record of verification decisions across federated governance domains.

Event-Driven Workflow Engines. Zapier, ServiceNow Flow Designer, Microsoft Power Automate, and similar platforms trigger downstream actions in response to events (e.g., “when a form is submitted, send an email and create a record”). An examiner might analogize this to “event→webhook.” However, these systems trigger on the occurrence of events, not on the outcome of verification against pre-registered acceptance criteria with per-criterion tolerance bands. They have no verification engine, no tolerance band definitions, no expansion algorithm, and no re-verification mechanism. The “trigger” in an event-driven workflow is the existence of an event; the “trigger” in the present invention is a marginal verification failure evaluated against multi-dimensional acceptance criteria, followed by deterministic re-execution with programmatically expanded tolerance parameters.

### Gap in the Art

No existing system provides a mechanism where: (1) the same deterministic verification engine that produced the original outcome is re-invoked; (2) the re-invocation uses the identical task attestation evidence from the original verification; (3) only the tolerance parameters are systematically expanded according to deterministic, per-dimension rules; (4) the re-execution produces a deterministic result that is compared to the original; and (5) the original outcome, the expanded parameters, and the revised outcome are atomically recorded in a tamper-evident audit chain within a single database transaction.

The present invention fills this gap by providing a general tolerance-parameterized re-verification method applicable to dispute resolution, graduated acceptance, multi-tier verification policies, and settlement signal supersession.

### BRIEF DESCRIPTION OF THE FIGURES

FIG. 1: System architecture diagram showing the relationship between the verification engine, the tolerance expansion module, the re-verification coordinator, the persistent data store, and the tamper-evident audit chain.

FIG. 2: Flowchart depicting the tolerance expansion algorithm, from re-verification trigger through per-dimension tolerance band computation, verification engine re-execution, outcome comparison, and atomic state transition.

FIG. 3: Visual comparison of original tolerance bands versus expanded tolerance bands for three criterion types (percentage-based, absolute-value, and time-based), showing the expanded acceptance regions.

FIG. 4: State transition diagram for the dispute lifecycle state machine, showing all valid transitions between states (OPENED, TIER_1_REVIEW, EVIDENCE_WINDOW, TIER_2_REVIEW, ESCALATED, TIER_3_ARBITRATION, RESOLVED, WITHDRAWN).

FIG. 5: Sequence diagram showing the temporal relationship between original verification, re-verification trigger, tolerance expansion computation, verification engine re-execution, atomic state transition, and settlement signal emission-all within a single database transaction.

### SUMMARY OF THE INVENTION

The present invention provides a computer-implemented method and system for re-executing a deterministic verification engine with programmatically expanded tolerance parameters to produce a revised verification outcome. The invention is applicable to any scenario where a prior verification outcome may be revisited by systematically widening the acceptance criteria while keeping the evidence unchanged, including but not limited to dispute resolution, graduated acceptance policies, multi-tier verification, and settlement signal supersession.

The core mechanism operates as follows: when a re-verification is triggered—whether by a dispute initiation, a graduated acceptance policy, a configurable re-verification schedule, or an external system request—the system retrieves the original tolerance band definitions from the task specification record, computes expanded tolerance band definitions by applying per-dimension expansion rules, and re-executes the same deterministic verification engine against the same task attestation evidence using the expanded tolerance parameters. Because the verification engine is a pure function of its inputs (criteria, evidence, tolerance parameters), the re-execution is fully deterministic—the same inputs always produce the same output.

If the re-verification produces a passing outcome under the expanded tolerance parameters, the system atomically transitions the associated records to reflect the revised outcome and persists a tamper-evident audit record capturing both the original and expanded tolerance parameters, the original and revised verification outcomes, and the expansion rules applied. If a settlement signal system is connected, a supersession signal (RELEASE) is emitted to notify downstream systems that a prior failing signal (HOLD) has been superseded.

If the re-verification still produces a failing outcome even under expanded tolerance parameters, the system may escalate to further processing-such as additional evidence submission windows, subsequent expansion tiers with progressively wider parameters, or human review-depending on the configured policy.

The deterministic, criteria-driven nature of the expansion distinguishes the present invention from all prior art: the expansion multiplier and additive adjustments are defined rules operating on the same per-criterion tolerance structures used by the original verification, not discretionary human judgment, monetary negotiation ranges, or juror voting.

### DETAILED DESCRIPTION OF PREFERRED EMBODIMENTS

The following detailed description sets forth various embodiments of the present invention. Reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

### Terminology Bridge

As used herein, the term “computational entity” encompasses any autonomous or semi-autonomous software component capable of performing tasks in a distributed computing environment, including but not limited to autonomous software agents, microservices, robotic process automation (RPA) workflows, IoT device controllers, orchestration engines, and human-supervised automated systems. The term “agent” is used as convenient shorthand for any such computational entity throughout this specification and should not be construed as limiting the invention to any particular type of software architecture or autonomy level.

The term “task specification record” refers to a data structure comprising registered acceptance criteria with declared tolerance bands that define the contractual terms against which a computational entity's task performance is measured. In the accompanying reference implementation, this structure is referred to as a “mandate.”

The term “task attestation evidence” refers to a structured data record submitted by a performing computational entity as proof of task completion against the criteria defined in the corresponding task specification record. In the accompanying reference implementation, this structure is referred to as a “receipt.”

The term “tolerance-parameterized re-verification” (TPR) refers to the core mechanism of the present invention: re-executing a deterministic verification engine against unchanged task attestation evidence using programmatically modified tolerance parameters, and atomically recording both the original and revised outcomes. TPR is distinguished from conventional retry mechanisms (which re-execute with identical parameters), from manual parameter adjustment (which requires human intervention), and from graduated SLA systems (which define all tiers as independent fixed thresholds rather than deriving expanded parameters from original parameters).

### System Arch

Referring now to FIG. 1, a preferred embodiment of the system comprises the following components operating in cooperation:

Verification Engine. A deterministic function executing on one or more processors, configured to accept as inputs: (a) a rules configuration specifying which verification rules to execute, (b) acceptance criteria from a task specification record, (c) evidence data from task attestation evidence, (d) tolerance band definitions, and (e) an optional configuration object. The engine iterates through each rule specified in the rules configuration, invokes the rule's check function with the criteria, evidence, and tolerance parameters, and collects per-criterion results. The overall outcome is the logical conjunction of all per-criterion results. The verification engine is a pure function: given identical inputs, it always produces identical outputs. This property is essential to the present invention, as it enables re-execution with modified tolerance parameters to produce a deterministic and reproducible revised result.

In the preferred embodiment, the verification engine operates in two phases. A synchronous structural validation phase confirms that the task attestation evidence conforms to the expected schema for the contract type—verifying required fields are present, data types are correct, and the evidence envelope is well-formed. This structural validation is performed synchronously at evidence submission time and completes in under 100 milliseconds. An asynchronous semantic verification phase then evaluates each acceptance criterion field-by-field against the tolerance bands, executing the per-dimension rules checks that produce the per-criterion pass/fail results. The two-phase architecture enables the re-verification mechanism of the present invention to reuse the structural validation result from the original verification (since the evidence has not changed) and re-execute only the semantic verification phase with expanded tolerance band definitions, reducing computational overhead.

Tolerance Expansion Module. A component configured to receive original tolerance band definitions and produce expanded tolerance band definitions according to configurable, per-dimension expansion rules. The expansion module supports multiple expansion strategies: multiplicative expansion (multiplying numeric tolerance values by a defined factor), additive expansion (adding a defined increment to tolerance values), and hybrid expansion (applying different strategies to different tolerance dimensions). The expansion module resolves the applicable expansion policy through a three-level specificity hierarchy: (1) a global default expansion policy that applies to all re-verifications unless overridden; (2) a per-contract-type expansion policy, defined in the contract type registry, that overrides the global default for all task specification records of that contract type; and (3) a per-task-specification-record expansion policy, defined on the individual task specification record at creation time, that overrides the per-contract-type policy. The most specific policy that exists is applied; absent a per-record policy, the per-contract-type policy is used; absent both, the global default applies.

Re-Verification Coordinator. A component configured to orchestrate the re-verification process: retrieving original tolerance parameters and task attestation evidence, invoking the tolerance expansion module, re-executing the verification engine with expanded parameters, comparing the revised outcome to the original, and coordinating atomic state transitions.

Persistent Data Store. A relational database management system configured to store task specification records, task attestation evidence records, verification result records, and associated metadata. In the preferred embodiment, the persistent data store is PostgreSQL.

Tamper-Evident Audit Chain. An append-only chain of records where each entry's integrity hash is computed from the entry's content concatenated with the preceding entry's hash, forming a sequential chain that makes retroactive modification detectable. Each entry is further signed with an Ed25519 asymmetric digital signature key, enabling offline verification of chain integrity without database access. Recording of re-verification events occurs atomically within the same database transaction as the state changes they document.

### Tolerance Band Data Model

In the preferred embodiment, tolerance bands are stored as a structured object on the task specification record at creation time. The tolerance object is a key-value map where each key identifies a specific tolerance parameter and each value is a numeric quantity. The following tolerance types are supported:

Percentage-Based Tolerance (quantity_pct). Specifies a symmetric percentage band around a target value. Given a target quantity T and a tolerance percentage P: lower bound=T×(1−P/100), upper bound=T×(1+P/100). Pass condition: actual>=lower bound AND actual<=upper_bound. Example: Target=500, quantity_pct=5 yields acceptance range 475-525.

Absolute-Value Tolerance (price_margin, budget_margin). Specifies a fixed numeric amount added to a ceiling or budget threshold. Given a ceiling value C and an absolute margin M: pass condition=actual<=C+M. Example: Price ceiling=2250, price_margin=50 yields maximum acceptable price 2300.

Percentage-Based Ceiling Tolerance (price_margin_pct). Specifies a percentage margin above a ceiling value. Given a ceiling value C and a percentage margin P: pass condition=actual<=C×(1+P/100). Example: Price ceiling=2250, price_margin_pct=2 yields maximum acceptable price 2295.

Time-Based Tolerance (grace_seconds). Specifies a fixed number of seconds added to a deadline timestamp. Given a deadline timestamp D and a grace period G (in seconds): effective deadline=D+G seconds, pass condition=submission_timestamp<=effective_deadline. Example: Deadline=2026-03-15T00:00:00Z, grace_seconds=86400 permits submission up to 2026-03-16T00:00:00Z.

Each tolerance type may be expanded independently during re-verification. The expansion rules are dimension-aware: a multiplicative expansion factor applied to quantity_pct produces a wider percentage band, while the same factor applied to grace_seconds produces a longer grace period. This per-dimension independence ensures that tolerance expansion is granular and predictable.

### Tolerance Expansion Algorithm

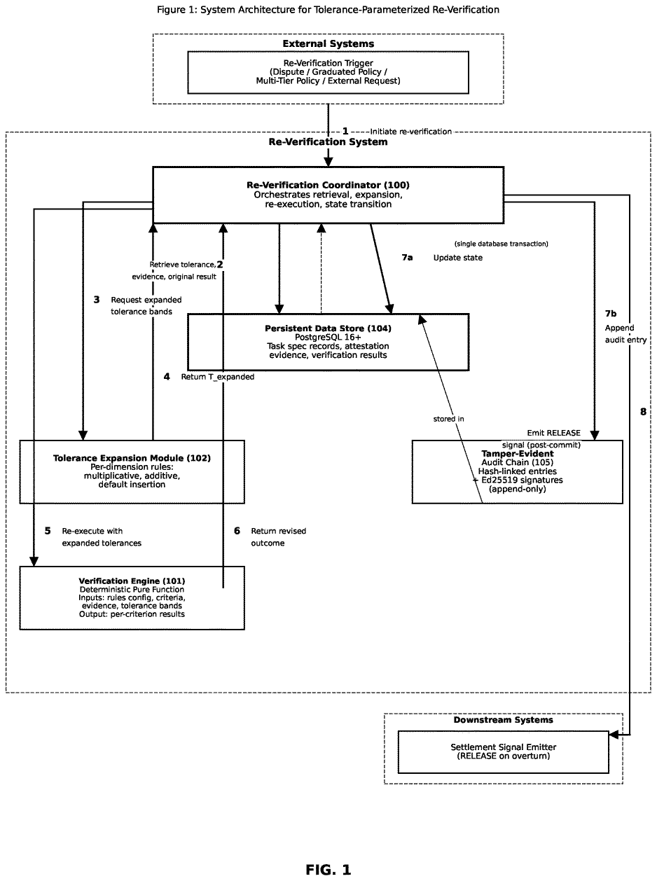

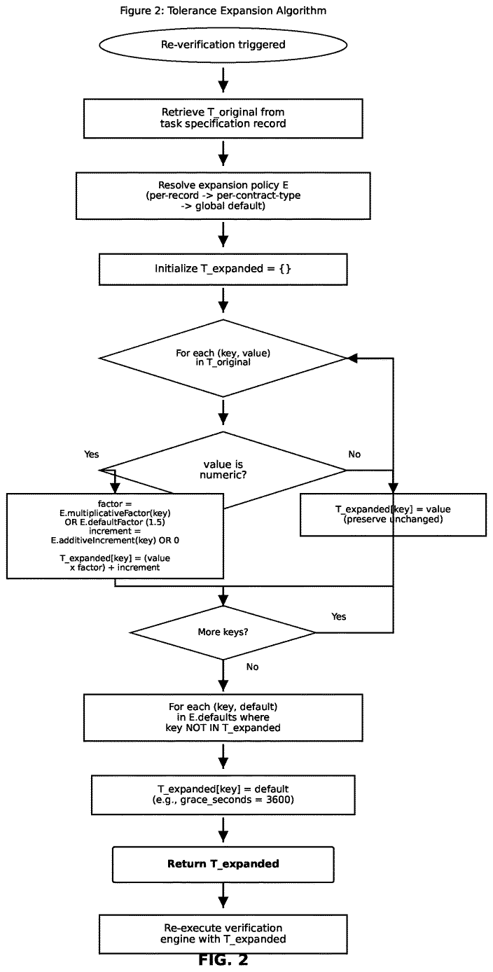

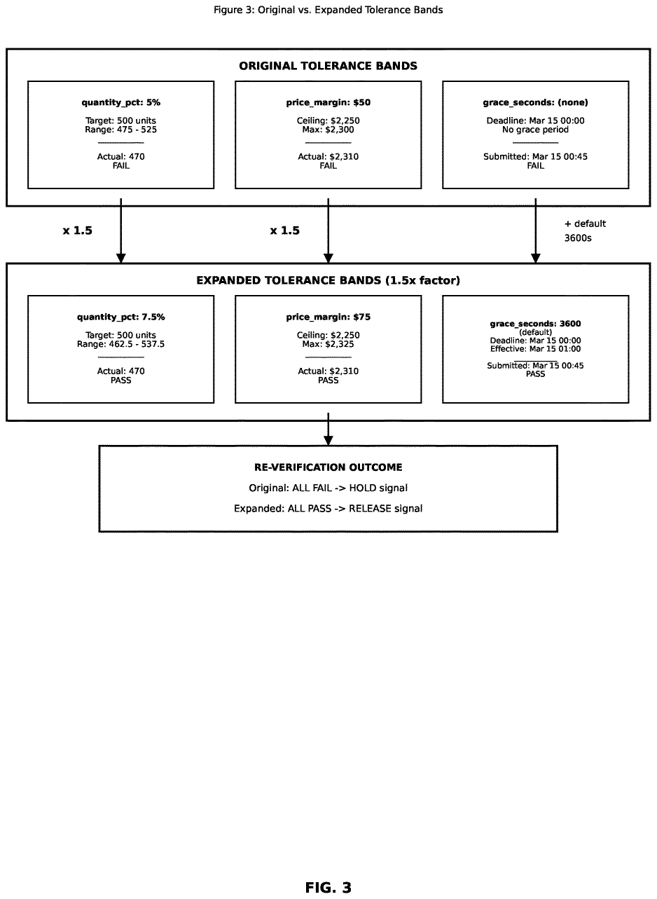

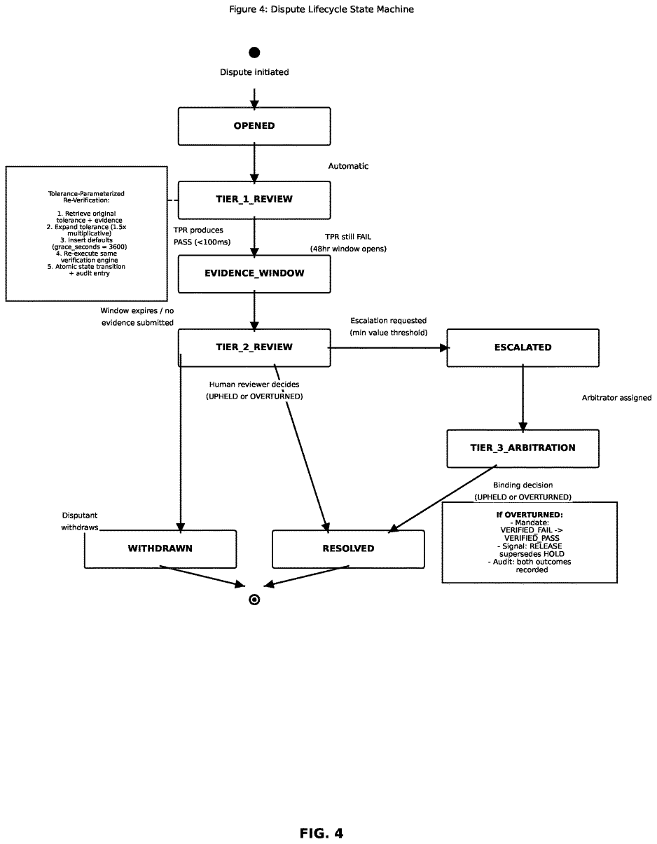

Referring now to FIG. 2, the tolerance expansion algorithm of the present invention is shown. Given an original tolerance object T_original and an expansion policy E, the algorithm produces an expanded tolerance object T_expanded as follows:

For each key-value pair (k, v) in T_original: if v is a numeric value and E specifies a multiplicative factor M for dimension k, then T_expanded[k]=v×M. If E specifies an additive increment A for dimension k, then T_expanded[k]=v+A. If E specifies both multiplicative and additive components, the multiplicative factor is applied first, then the additive increment: T_expanded[k]=(v×M)+A. If v is not numeric, T_expanded[k]=v (preserved unchanged).

For dimensions not present in T_original but specified in E with a default value, the expansion algorithm inserts the default value into T_expanded. For example, if the original tolerance does not specify grace_seconds but the expansion policy defines a default grace period of 3600 seconds, the expanded tolerance will include grace_seconds=3600.

In the preferred embodiment, the default expansion policy applies a uniform multiplicative factor of 1.5 (50% wider bands) to all numeric tolerance values and inserts a default grace_seconds of 3600 when no deadline tolerance is specified. The expansion policy may be overridden at the contract-type level or at the individual task specification record level.

The following pseudocode illustrates the expansion algorithm:

```
FUNCTION expandTolerance (original, policy):
  expanded = { }
  FOR EACH (key, value) IN original:
    IF value IS NUMERIC:
      factor = policy.multiplicativeFactor[key] OR policy.defaultFactor
      increment = policy.additiveIncrement[key] OR 0
      expanded[key] = (value * factor) + increment
    ELSE:
      expanded[key] = value
  FOR EACH (key, defaultValue) IN policy.defaults:
    IF key NOT IN expanded:
      expanded[key] = defaultValue
  RETURN expanded
```

### Re-Verification Process

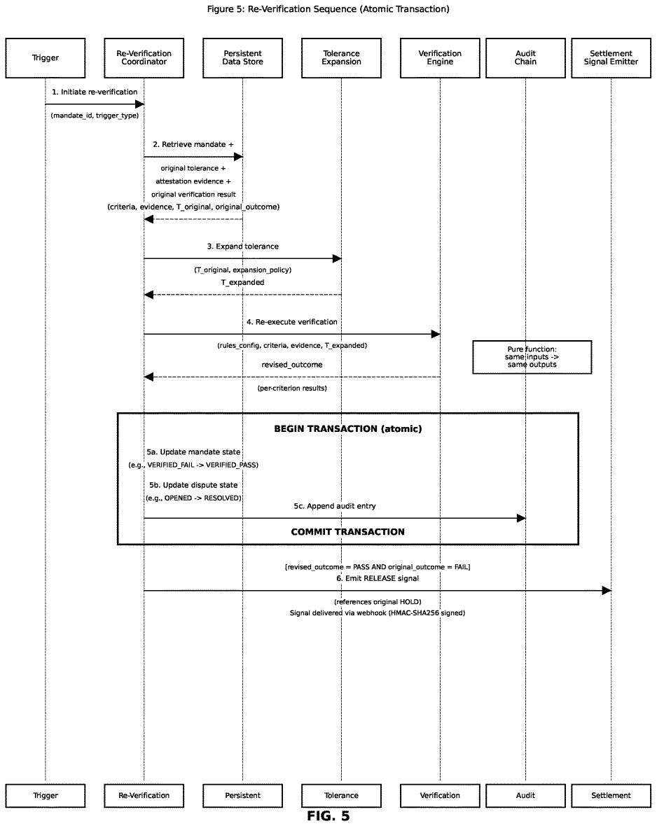

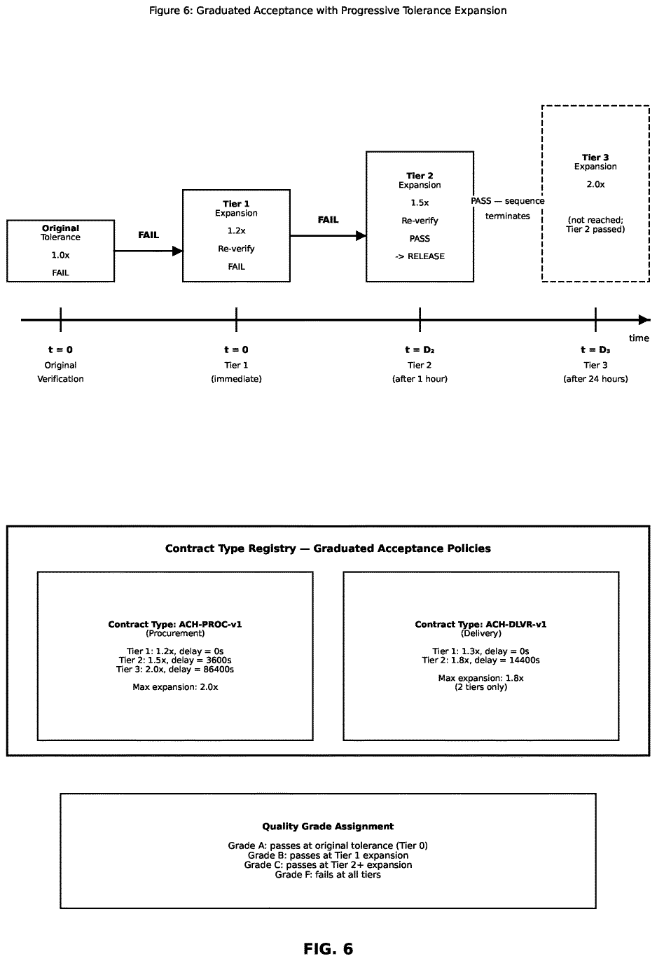

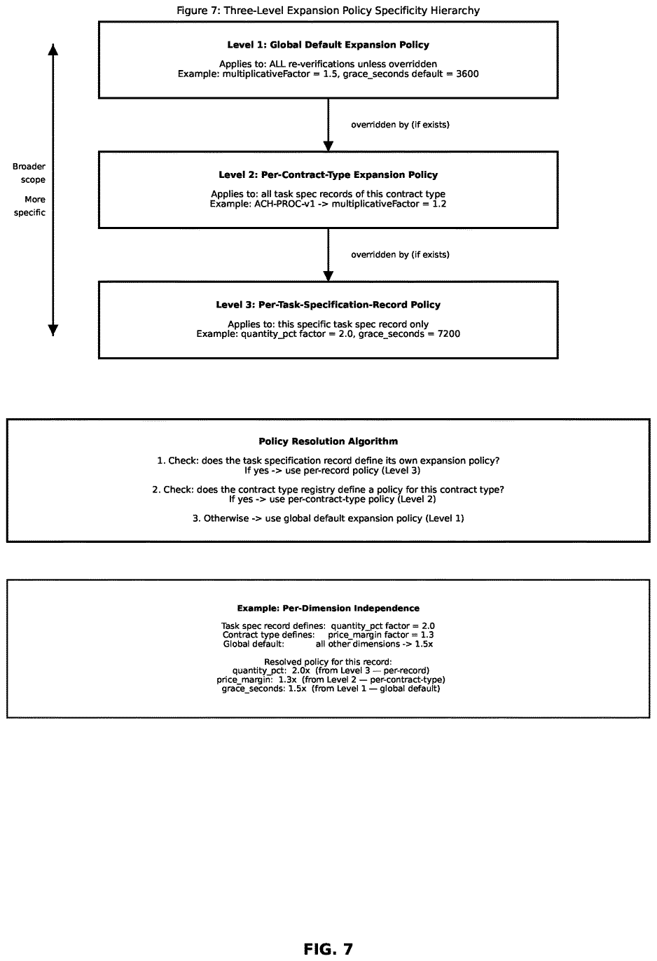

Referring now to FIG. 5, the re-verification process of the present invention operates as follows:
Step 1: Trigger. A re-verification is triggered by one of: (a) a dispute initiation request referencing a task specification record with a prior verification outcome; (b) a graduated acceptance policy that automatically triggers re-verification with progressively wider tolerances after a configurable delay following a failing outcome; (c) a multi-tier verification policy that defines multiple tolerance levels to be evaluated in sequence; or (d) an external system request via a programmatic interface.
Step 2: Retrieval. The re-verification coordinator retrieves from the persistent data store: the task specification record including its original tolerance band definitions, the task attestation evidence that was evaluated during the original verification, and the original verification result including per-criterion outcomes.
Step 3: Expansion. The tolerance expansion module computes expanded tolerance band definitions by applying the expansion policy to the original tolerance parameters. The expansion policy, the original parameters, and the expanded parameters are all recorded for audit purposes.
Step 4: Re-Execution. The verification engine is re-executed with the following inputs: the same rules configuration as the original verification, the same acceptance criteria from the task specification record, the same task attestation evidence, and the expanded tolerance band definitions. Because the verification engine is a pure function, this re-execution is fully deterministic.
Step 5: Outcome Comparison. The re-verification coordinator compares the revised verification outcome to the original. If the original outcome was FAIL and the revised outcome is PASS, the re-verification has succeeded—the evidence satisfies the acceptance criteria under the expanded tolerance parameters. If the revised outcome is still FAIL, the evidence fails even under expanded tolerances.
Step 6: Atomic State Transition. Within a single database transaction, the system: (a) transitions the associated records to reflect the revised outcome (e.g., mandate from VERIFIED FAIL to VERIFIED_PASS, dispute from OPENED to RESOLVED with OVERTURNED outcome); (b) persists a tamper-evident audit chain entry recording the re-verification event, including the original tolerance parameters, the expanded tolerance parameters, the expansion policy applied, the original verification outcome, and the revised verification outcome; and (c) commits the transaction.
Step 7: Signal Emission. If a settlement signal system is connected and the re-verification produced a passing outcome that supersedes a prior failing outcome, a RELEASE signal is emitted to notify downstream systems that a previously-issued HOLD signal has been superseded. The RELEASE signal references the original HOLD signal that it supersedes. Signal emission occurs after the database transaction has been committed, ensuring that the signal reflects a durable state change.

### Dispute-Triggered Re-Adjudication

In a preferred embodiment, the re-verification mechanism is applied to dispute resolution through a multi-tier escalation process:
Tier 1 (Automated Re-Adjudication). When a dispute is initiated against a task specification record that has received a failing verification outcome, the system immediately executes the tolerance-parameterized re-verification process described above. The expansion policy for Tier 1 applies a uniform 1.5× multiplicative factor to all numeric tolerance values and inserts a default 3600-second grace period if no deadline tolerance exists. If the re-verification produces a passing outcome, the dispute is automatically resolved with an OVERTURNED outcome, and the task specification record transitions to a passing verification state-all within a single database transaction, typically completing in less than 100 milliseconds. If the re-verification still fails, the dispute transitions to an evidence submission window.
Tier 2 (Evidence Window+Human Review). A 48-hour evidence submission window opens, during which parties may submit additional evidence (screenshots, external records, communications). After the window closes or evidence is submitted, the dispute enters human review. A flat fee is assessed to the losing party upon resolution.
Tier 3 (Binding Arbitration). If Tier 2 does not resolve the dispute, it may be escalated to formal binding arbitration with a higher flat fee and a minimum dispute value threshold. The fee is assessed to the losing party or split according to the arbitrator's determination.

The tiered structure ensures that marginal failures—those that would pass under slightly wider tolerances—are resolved instantly and deterministically at Tier 1, without human involvement or cost. Only disputes involving evidence outside even the expanded tolerance bands escalate to human review.

### Graduated Acceptance Policy

In an alternative embodiment, the tolerance-parameterized re-verification mechanism is applied automatically without requiring an explicit dispute initiation. A graduated acceptance policy may be defined on a per-task-specification-record basis or per-contract-type basis, specifying:

A sequence of expansion tiers, each with its own expansion policy (e.g., Tier 1:1.2×, Tier 2:1.5×, Tier 3:2.0×). A delay period between tiers (e.g., re-verify at 1.2× immediately, at 1.5× after 1 hour, at 2.0× after 24 hours). An optional maximum expansion limit beyond which the failing outcome is considered final.

When the original verification produces a failing outcome, the system automatically schedules re-verification at each tier according to the defined delays. If any tier's re-verification produces a passing outcome, the verification state is updated and downstream signals emitted. This mechanism enables progressive tolerance relaxation for time-sensitive operations where marginal failures may self-resolve as additional processing time elapses.

In the preferred embodiment, the graduated acceptance policy is defined in a contract type registry—a configuration store that maps each contract type identifier (e.g., “ACH-PROC-v1”, “ACH-DLVR-v1”) to its associated verification rules, tolerance expansion policies, and graduated acceptance tier sequences. Different contract types may define different numbers of tiers, different expansion factors per tier, and different delay periods between tiers. For example, a procurement contract type may define three tiers (1.2×/immediate, 1.5×/1 hour, 2.0×/24 hours), while a delivery contract type may define only two tiers (1.3×/immediate, 1.8×/4 hours) reflecting the different tolerance profiles of these task categories.

### Multi-Tier Verification Policy

In a further alternative embodiment, the tolerance-parameterized re-verification mechanism is used to implement multi-tier verification where different tolerance levels correspond to different service quality grades. A task specification record may define a strict tolerance set (the contractual minimum), a standard tolerance set (acceptable range), and a lenient tolerance set (maximum acceptable deviation). The verification engine is executed against all three tolerance sets, and the results are reported as a quality grade: the evidence meets strict criteria (grade A), standard criteria (grade B), lenient criteria (grade C), or fails even lenient criteria (grade F). This multi-tier approach provides richer information to downstream systems than a binary pass/fail outcome.

### Settlement Signal Integration

When the present invention is deployed in conjunction with the settlement signal system described in co-pending U.S. Non-Provisional application Ser. No. 19/565,072, the re-verification outcome directly triggers signal emission. Specifically:

When an original verification produces a FAIL outcome, a HOLD signal is emitted to registered downstream system endpoints. When a subsequent tolerance-parameterized re-verification produces a PASS outcome that supersedes the prior FAIL, a RELEASE signal is emitted referencing the original HOLD signal. The RELEASE signal carries the same cryptographic signing, delivery authentication, and retry mechanisms as described in the settlement signal application. In federated deployments, the RELEASE signal traverses governance domain boundaries with the same dual-layer signature architecture (origin signature+relay signature) as other settlement signals.

Each settlement signal is a data structure comprising: a signal type field indicating one of SETTLE, HOLD, or RELEASE; a reference identifier linking the signal to the originating task specification record; a supersession reference that, when present, identifies the prior signal being superseded (the RELEASE signal references the HOLD signal it supersedes); a cryptographic signature computed over the canonicalized signal payload using an Ed25519 asymmetric signing key; and a delivery timestamp. The signal is transmitted to registered downstream system endpoints via authenticated webhook delivery (HMAC-SHA256 signed HTTP POST requests) independently of the database transaction that recorded the re-verification outcome, ensuring that signal delivery failures do not block or roll back the durable verification state change.

### Audit Chain Integration

Every re-verification event is recorded in the tamper-evident audit chain within the same database transaction as the state changes it produces. The audit entry for a re-verification event includes:

The re-verification trigger type (dispute, graduated acceptance, multi-tier policy, or external request). The original tolerance band definitions. The expansion policy applied (multiplicative factors, additive increments, defaults inserted). The expanded tolerance band definitions. The original verification outcome (per-criterion results and aggregate outcome). The revised verification outcome (per-criterion results and aggregate outcome). The state transitions applied (e.g., mandate status change, dispute status change). A timestamp indicating when the re-verification was executed.

This comprehensive audit record enables after-the-fact review of every re-verification decision: an auditor can independently verify that the expansion was applied correctly, that the verification engine produced the expected result given the expanded parameters, and that the state transitions were consistent with the outcome.

### Verification Engine Determinism

A critical property of the present invention is that the verification engine is a pure function: given identical inputs (rules configuration, acceptance criteria, task attestation evidence, tolerance band definitions), it always produces identical outputs. This determinism has several important consequences:

Reproducibility. Any re-verification can be independently reproduced by providing the same inputs to the verification engine. The audit chain records all inputs, enabling third-party verification.

Consistency. Two task specification records with identical criteria, evidence, and tolerance parameters will always receive identical verification outcomes, regardless of when or how many times the verification is executed.

Auditability. The deterministic property, combined with the tamper-evident audit chain, creates a fully auditable re-verification history where every outcome can be independently validated.

The determinism requirement constrains the verification engine design: rules must not depend on external state that may change between the original verification and the re-verification (e.g., current market prices, real-time API responses). In the preferred embodiment, all verification inputs are captured at the time of original verification and stored in the persistent data store, ensuring that re-verification operates on the same snapshot of data.

What is claimed is:

1. A computer-implemented method for re-verifying task completion evidence using modified tolerance parameters in a distributed computing environment, the method operating independently of a shared ledger or consensus protocol, the method comprising: (a) retrieving, from a persistent data store, a task specification record comprising acceptance criteria and original tolerance band definitions, and task attestation evidence previously evaluated against the acceptance criteria to produce an original verification outcome; (b) computing expanded tolerance band definitions by applying one or more expansion rules to the original tolerance band definitions, each expansion rule operating on a per-dimension basis such that different tolerance dimensions may be expanded by different amounts; (c) re-executing a deterministic verification engine against the task attestation evidence using the acceptance criteria and the expanded tolerance band definitions, the deterministic verification engine being the same engine that produced the original verification outcome, and producing a revised verification outcome; and (d) atomically recording, within a single database transaction in the persistent data store, the original tolerance band definitions, the expanded tolerance band definitions, the expansion rules applied, the original verification outcome, and the revised verification outcome in a tamper-evident audit chain comprising hash-linked entries.

2. A computer-implemented method for automated re-adjudication of a verification outcome via tolerance-parameterized re-verification in a distributed computing environment, the method comprising: (a) receiving a dispute initiation request referencing a task specification record that has undergone verification and received a failing verification outcome, the task specification record comprising acceptance criteria with per-criterion tolerance band definitions specified at task specification record creation time; (b) retrieving, from a persistent data store, the task attestation evidence that was evaluated during the original verification; (c) computing expanded tolerance band definitions by applying a defined expansion policy to each tolerance band definition in the original tolerance band definitions; (d) re-executing, within a single database transaction, the same deterministic verification engine that produced the original failing outcome against the same task attestation evidence using the expanded tolerance band definitions; (e) responsive to the re-executed verification producing a passing outcome under the expanded tolerance band definitions, atomically transitioning a dispute record to a resolved state with an overturned outcome and transitioning the task specification record from the failing verification state to a passing verification state, within the same database transaction; (f) responsive to the re-executed verification producing a failing outcome even under the expanded tolerance band definitions, transitioning the dispute record to an escalated state; and (g) persisting each state transition as an audit record in the tamper-evident audit chain within the same database transaction.

3. The method of claim 2, wherein the expansion policy applies a uniform multiplicative factor to all numeric tolerance values, such that a tolerance band originally permitting a 5% quantity variance is expanded to permit a 7.5% quantity variance when the multiplicative factor is 1.5.

4. The method of claim 2, wherein the expansion policy includes an additive grace period increment applied to time-based tolerance values, the additive increment being a fixed number of seconds added to any deadline tolerance, independent of the original deadline value.

5. The method of claim 2, wherein the expansion policy inserts a default tolerance value for tolerance dimensions not present in the original tolerance band definitions, such that a task specification record created without a deadline grace period receives a default grace period during re-verification.

6. The method of claim 2, wherein the expansion policy specifies per-dimension expansion rules such that different tolerance dimensions are expanded by different multiplicative factors or additive increments, whereby a percentage-based tolerance dimension and a time-based tolerance dimension on the same task specification record may each receive a distinct expansion factor.

7. The method of claim 2, further comprising, responsive to the re-executed verification producing a passing outcome, emitting a RELEASE settlement signal indicating that a previously-issued HOLD settlement signal has been superseded, the RELEASE signal referencing the identifier of the original HOLD signal and carrying a cryptographic signature of the emitting node.

8. The method of claim 2, wherein the re-executed verification evaluates each acceptance criterion independently against its corresponding expanded tolerance band and produces a per-criterion result, and wherein the revised verification outcome is the logical conjunction of all per-criterion results.

9. The method of claim 2, wherein upon escalation in step (f), the dispute record transitions to an EVIDENCE WINDOW state with a defined time limit measured in hours for additional evidence submission, and further comprising, responsive to the time limit expiring without submission of additional evidence, transitioning the dispute record to a TIER 2 REVIEW state for human review.

10. The method of claim 1, wherein the expansion rules comprise a multiplicative factor applied to percentage-based tolerance values, an additive increment applied to time-based tolerance values, and a multiplicative factor applied to absolute-value tolerance values, each operating independently on its respective tolerance dimension.

11. The method of claim 1, wherein the deterministic verification engine is a pure function such that given identical inputs comprising a rules configuration, acceptance criteria, task attestation evidence, and tolerance band definitions, the engine always produces identical outputs, and wherein this determinism enables independent reproduction of any re-verification result by providing the recorded inputs to the engine.

12. The method of claim 1, wherein the tamper-evident audit chain entry for the re-verification event further comprises: a trigger type identifying the condition that initiated the re-verification, the per-criterion results from both the original verification and the re-verification, and a timestamp indicating when the re-verification was executed.

13. The method of claim 1, further comprising, responsive to the revised verification outcome differing from the original verification outcome, transitioning the task specification record from a state reflecting the original outcome to a state reflecting the revised outcome within the same database transaction.

14. The method of claim 1, wherein the task attestation evidence used in the re-verification is the same record stored in the persistent data store at the time of original evidence submission, such that the re-verification operates on byte-identical evidence data as the original verification.

15. A computer-implemented method for graduated acceptance of task completion evidence using progressively expanded tolerance parameters, the method comprising: (a) receiving, at a verification engine executing on one or more processors, task attestation evidence submitted against a task specification record comprising acceptance criteria and original tolerance band definitions; (b) executing the verification engine against the task attestation evidence using the original tolerance band definitions and obtaining an original verification outcome; (c) responsive to the original verification outcome being a failing outcome, automatically initiating an ordered sequence of re-verification tiers numbered 1 through N, where each tier n has an expansion policy that produces wider tolerance band definitions than tier n−1, the sequence comprising: computing expanded tolerance band definitions for tier n by applying tier n's expansion policy to the original tolerance band definitions; re-executing the verification engine against the same task attestation evidence using the expanded tolerance band definitions for tier n; if the re-verification produces a passing outcome, recording tier n as the tier at which passing was achieved and terminating the sequence; if the re-verification produces a failing outcome and n<N, advancing to tier n+1; (d) atomically recording, for each tier evaluated, the expansion policy applied, the expanded tolerance band definitions, and the verification outcome in a tamper-evident audit chain.

16. The method of claim 15, wherein each tier n in the ordered sequence is associated with a delay period D_n measured in seconds from the time of the original failing verification outcome, and the re-verification for tier n is not executed until D_n seconds have elapsed, such that tier 1 may execute immediately (D_1=0), tier 2 executes after D_2 seconds, and tier N executes after D N seconds.

17. The method of claim 15, wherein the sequence of re-verification tiers is defined on a per-contract-type basis in a contract type registry, such that different types of task specification records have different graduated acceptance policies.

18. The method of claim 15, further comprising associating the tier at which passing was achieved with a quality grade indicator selected from an ordered set of grades, wherein a passing outcome at the original tolerance level (tier 0) corresponds to grade A, a passing outcome at tier 1 corresponds to grade B, a passing outcome at tier 2 or higher corresponds to grade C, and a failing outcome at all tiers corresponds to grade F, the quality grade indicator being included in the audit chain entry and in any downstream signals or reports.

19. A system for tolerance-parameterized re-verification in a distributed computing environment, comprising: (a) a verification engine executing on one or more processors, the verification engine being a deterministic pure function configured to accept acceptance criteria, task attestation evidence, and tolerance band definitions as inputs and produce a verification outcome as output; (b) a tolerance expansion module configured to receive original tolerance band definitions and an expansion policy, and produce expanded tolerance band definitions by applying per-dimension expansion rules comprising one or more of multiplicative factors, additive increments, and default value insertions; (c) a re-verification coordinator configured to retrieve original verification inputs from a persistent data store, invoke the tolerance expansion module, re-execute the verification engine with expanded tolerance band definitions, and compare the revised verification outcome to the original verification outcome; (d) a persistent data store configured to store task specification records, task attestation evidence records, and verification result records; and (e) a tamper-evident audit chain configured to atomically record, within the same database transaction as any state changes, re-verification events comprising original tolerance parameters, expanded tolerance parameters, expansion rules applied, original verification outcomes, and revised verification outcomes.

20. The system of claim 19, further comprising a dispute resolution module configured to receive dispute initiation requests, invoke the re-verification coordinator with a dispute-specific expansion policy, and responsive to the re-verification producing a passing outcome, atomically transition both the dispute record and the task specification record within a single database transaction.

21. The system of claim 19, further comprising a graduated acceptance scheduler configured to automatically schedule an ordered sequence of re-verifications numbered 1 through N after a failing verification outcome, where each re-verification n applies an expansion policy that produces wider tolerance band definitions than re-verification n−1, and each re-verification n is triggered after a configurable delay period D_n measured in seconds from the time of the original failing outcome.

22. The system of claim 19, further comprising a settlement signal emitter configured to emit a supersession signal when a re-verification produces a passing outcome that supersedes a prior failing outcome, the supersession signal carrying a cryptographic signature and referencing the original signal.

23. The system of claim 19, wherein the tolerance expansion module supports configurable expansion policies defined at three levels of specificity: a global default expansion policy, a per-contract-type expansion policy that overrides the global default, and a per-task-specification-record expansion policy that overrides the per-contract-type policy.

24. The system of claim 19, wherein the verification engine comprises a synchronous structural validation phase that confirms schema conformance of task attestation evidence, and an asynchronous semantic verification phase that evaluates field-by-field criteria compliance with tolerance bands, and wherein the re-verification re-executes the asynchronous semantic verification phase with expanded tolerance band definitions while reusing the structural validation result from the original verification.

25. A non-transitory computer-readable storage medium storing instructions that, when executed by one or more processors coupled to a persistent data store, cause the processors to perform the method of claim 1.

26. A non-transitory computer-readable storage medium storing instructions that, when executed by one or more processors coupled to a persistent data store, cause the processors to perform the method of claim 2.

27. A non-transitory computer-readable storage medium storing instructions that, when executed by one or more processors coupled to a persistent data store, cause the processors to perform the method of claim 15.

28. The method of claim 1, further comprising, responsive to the revised verification outcome differing from the original verification outcome, generating a settlement signal data structure comprising: a signal type field indicating one of SETTLE, HOLD, or RELEASE; a reference identifier linking the signal to the task specification record; a supersession reference identifying a prior signal that the current signal supersedes, the supersession reference being present when the signal type is RELEASE; a cryptographic signature computed over the signal payload using an asymmetric signing key; and a delivery timestamp, the settlement signal data structure being transmitted to one or more registered downstream system endpoints via authenticated webhook delivery independently of the database transaction.

29. The method of claim 1, wherein computing expanded tolerance band definitions in step (b) comprises resolving an applicable expansion policy from a three-level specificity hierarchy by: (i) determining whether a per-task-specification-record expansion policy is defined on the task specification record retrieved in step (a); (ii) if no per-task-specification-record expansion policy is defined, determining whether a per-contract-type expansion policy is defined for the contract type of the task specification record in a contract type registry; (iii) if no per-contract-type expansion policy is defined, applying a global default expansion policy; and (iv) applying the resolved expansion policy to produce the expanded tolerance band definitions, wherein the per-task-specification-record policy takes precedence over the per-contract-type policy, and the per-contract-type policy takes precedence over the global default policy.

30. The method of claim 1, wherein computing expanded tolerance band definitions in step (b) comprises executing an ordered sequence of operations for each tolerance dimension in the original tolerance band definitions: (i) for each key-value pair where the value is numeric, applying a multiplicative factor from the resolved expansion policy to the value, producing a scaled value; (ii) applying an additive increment from the resolved expansion policy to the scaled value, producing the expanded value for that dimension, wherein the multiplicative factor is applied before the additive increment such that the expanded value equals (original value×multiplicative factor)+additive increment; and (iii) after processing all key-value pairs present in the original tolerance band definitions, inserting default tolerance values from the resolved expansion policy for any tolerance dimensions not present in the original tolerance band definitions, such that the expanded tolerance band definitions may contain dimensions absent from the original.
